(19) United States
(12) Patent Application Publication
(10) Pub. No.: US 2008/0105774 A1
(43) Pub. Date: May 8, 2008

(54) Input port structure of shredder

(75) Inventor: Muneyuki Ishihara, Katsushika-ku (JP)

Correspondence Address: OLIFF & BERRIDGE, PLC, P.O. BOX 320850, ALEXANDRIA, VA, 22320-4850, US

(73) Assignee: CARL MANUFACTURING CO., LTD., TOKYO (JP)

(21) Appl. No.: 11/979,618

(22) Filed: Nov. 6, 2007

(30) Foreign Application Priority Data
Nov. 7, 2006 (JP) 2006-302168

(51) Int. Cl. B02C 7/11

(52) U.S. Cl. 241/285.1

(57) ABSTRACT

There is provided an input port structure of a shredder, the shredder comprising: an input port; a wall member including a wall surface directed to the input port; and a lock member that installs the wall member in a housing body, wherein: the wall member and the lock member have either a stepped portion with a plurality of steps or an engaged portion being engaged with the steps of the stepped portion; and by applying given external force to a passage directed to a shredded cutter in a direction to spread the passage relative to the wall member, the steps of the stepped portion engage with the engaged portion while maintaining an engaged condition between the wall member and the lock member.

### BACKGROUND OF THE INVENTION

1. Field of the Invention

The present invention relates to input port structure of shredders in which to finely cut sheet materials such as paper, compact discs, etc., and more particularly to input port structure of shredders enabling to pull out objects that should not be allowed for insertion from an input port of a shredder when the disallowed objects are about to be drawn into a cutting portion of the shredder thereby contributing to preventing an occurrence of injuries at the input port.

2. Description of the Related Art

As regards technique in which to prevent an occurrence of injuries caused by mistakenly inserting fingers into an input port of shredders, Japanese Patent Application Laid-Open No. 2005-95898 (hereinafter “reference 1”), for example, discloses the technique that a proximity sensor sensing the existence of persons or animals is provided nearby the input port of the shredders.

In addition, as regards technique in which to facilitate extraction of objects to be cut that are drawn into a cutter, Japanese Patent Application Laid-Open No. 2001-9312 (hereinafter “reference 2”) discloses the technique that a guide plate, directed to the side of an input port, is provided on a way of a guide passage led to a cutter portion. With this structure, opened width in a feeding direction will be narrower than the one in a reverse direction.

However, the technique disclosed in the reference 1 needs the proximity sensor that can sense to distinguish the disallowed objects such as persons or animals from the objects to be cut. Further, depending on positions in which the proximity sensor is placed, the sensor may mistakenly respond to the operator's hands when he introduces the objects into the input port of the shredder. This will deteriorate efficiency of cutting operation.

Especially, in shredders wherein a rotary cutter automatically rotates at the same time the objects are introduced into the input port of the shredder, a sensor detecting the introduction of the objects will be individually needed. Accordingly, not only the structure of the sensor becomes complicated, but also the operator is confronted with the difficulty of adjusting positions in which the sensor is placed. These eventually increase manufacturing costs as well as merchandise costs, which brings difficulties to make the merchandise pervaded in a market as household shredders.

Further, as regards the technique disclosed in the reference 2, it is effective when drawing out the objects from the input port of the shredder after suspending movement of the objects in a feeding direction. However, in case that the operator intends to instantaneously draw out the transited objects from the input port of the shredder, it does not work effectively. As a result, if the operator fingers are about to be drawn into the interior of the shredder along with the objects, the operator has difficulties to instantaneously draw out his fingers from the input port of the shredder. This thus increases possibilities that the operator fingers are drawn toward a rotary cutter.

### SUMMARY OF THE INVENTION

The present invention has been made in light of the above problems, and it is an object of the present invention to provide input port structure of shredders wherein the operator can instantaneously draw out objects that is not allowed for shredded operation (hereinafter referred to as “disallowed objects”) in case the disallowed objects are about to be drawn into shredding cutters of the shredders.

In order to achieve the object described above, according to a first aspect of the present invention, there is provided input port structure of a shredder, the shredder comprising: an input port; a wall member including a wall surface directed to the input port; and a lock member that installs the wall member in a housing body, wherein: the wall member and the lock member have either a stepped portion with a plurality of steps or an engaged portion being engaged with the steps of the stepped portion; and by applying given external force to a passage directed to a shredded cutter in a direction to spread the passage relative to the wall member, the steps of the stepped portion engage with the engaged portion while maintaining an engaged condition made between the wall member and the lock member.

As regards the above structure, if the force applied to the wall member is relatively small, the engaged condition in the steps remains. On the other hand, if the applied force exceeds given value, the engaged portion passes on each of the steps of the stepped portion to the appropriate place to be engaged. Accordingly, in case sheet-like objects are introduced into the input port, the initial state of the input port structure will remain. To the contrary, in case the objects relatively thick are introduced into the input port, the force more than the given value is applied to the wall member so as to spread the passage.

Furthermore, in case the operator's fingers or sheet materials, the thickness of which exceeds cutting capabilities of the shredder, are introduced into the input port, the wall member is displaced so as to spread the passage. The operator can thus easily and instantaneously draw out those disallowed objects, which are about to be drawn into a shredded portion. Here, since the engagement between the wall member and the lock member remains, the passage is restricted to be unduly spread even if the operator's fingers are forcibly inserted into the input port, thereby being able to prevent the fingers from being further inserted toward the shredded cutter.

As discussed above, in case the disallowed objects such as fingers are mistakenly inserted into the input port, the width of the passage will be spread to the extent only enough to draw out the disallowed objects. The operator can thus draw out his fingers instantaneously from the passage or the input port whereby the safety of the input port of the shredder will be improved.

In the first aspect of the present invention, the input port structure of the shredder may have the following features: the stepped portion is provided on the backside of the wall member; and a convex portion provided with the back member is housed within a concave portion provided nearby the stepped portion so as to engage the wall member with the lock member.

As regards the above structure, with members in relatively simple formation, while maintaining the condition that the wall member and the lock member are engaged, the engaged portion can be engaged with the stepped portion in a sequential manner. Furthermore, by adjusting the formation of the concave portion of the wall member and/or the convex portion of the lock member, the engaged condition made between the wall member and the lock member becomes adjustable. Accordingly, for example, by designing the interior configuration of the concave portion of the wall member in such a manner as to make the width of the spread passage smaller than the thickness of the fingers, the passage will spread to the extent only enough for drawing out the fingers from the input port in case the operator's fingers are inserted thereinto. Accordingly, the fingers will not get inserted into the passage due to the restriction of the passage to be spread.

In the first aspect of the present invention, the input port structure of the shredder may have the following features: the stepped level of the stepped portion is made elevated from the side on which the wall member is mounted to the side of the input port; and in the initial state that the wall member is mounted on the housing body, the engaged portion is engaged at the first-step portion positioned on the side on which the wall member is mounted.

As regards the above structure, while the wall member is displaced in the direction that the passage is spread (that is, to the side that the wall member is mounted), the wall member can be displaced to the side where departed from the housing body. Accordingly, by making the passage being spread, the wall member can be displaced in the direction where departed from the lock member, facilitating detachment of the wall member from the lock member.

In the first aspect of the present invention, the input port structure of the shredder may have the following features: the lock member is provided on the side-wall surface of the housing body in condition that the convex portion is directed upward toward the wall member; and the convex portion is housed within the concave portion of the wall member so as to use the wall member as the upper surface of the housing.

As regards the above structure, with members in relatively simple formation, it could achieve the shredder having the input port on the upper surface of the housing.

In the first aspect of the present invention, the input port structure of the shredder may have the following features: a lock releasing means is provided so as to release the engaged condition made between the wall member and the lock member.

As regards the above structure, the wall member becomes detachable. Accordingly, in case the objects are stuck in the shredded cutter, the wall member can be detached or largely departed from the housing body. This eventually facilitates removal of the objects stuck in the shredded cutter.

In the first aspect of the present invention, the input port structure of the shredder may have the following features: the lock releasing means intervenes between the housing body and the lock member; the lock member is made of an elastic member which energizes the lock member in the direction of the wall member; and an operation portion is provided so as to release the force applied by the elastic member.

As regards the above structure, with members in relatively simple structure, the engaged condition made between the wall member and the lock member can be easily released.

In the first aspect of the present invention, the input port structure of the shredder may have the following features: an introduction surface for introducing objects to be cut into the shredded cutter is provided on the housing body; and a passage surface, provided opposite to the introduction surface so as to form a passage with a certain width, is provided on the back surface of the wall member.

As regards the above structure, when the wall member is mounted on the housing body, the passage for the objects can be restricted with two surfaces: the introduction surface and the passage surface. The objects can thus be smoothly introduced into the shredded cutter.

### BRIEF DESCRIPTION OF THE DRAWINGS

FIG. 1 is a cross-sectional view mainly introducing input port structure of a shredder according to an embodiment of the present invention wherein FIG. 1A shows the shredder cut at the center portion thereof in a lateral direction while FIG. 1B shows the nearby portion of FIG. 1A;

FIG. 2 is a cross-sectional perspective view of the shredder applied to the input port structure of FIG. 1;

FIG. 3 is a perspective view of a housing body in condition that a wall member is removed;

FIG. 4 is a front view showing the first rotary cutter;

FIG. 5 is a perspective view of the first rotary cutter in detail;

FIG. 6 is an explanatory view showing the structure of the rotary cutter in FIGS. 4 and 5;

FIG. 7 is an explanatory view showing the thickness of finger;

FIG. 8 is a perspective view of the wall member viewed from the back side thereof;

FIG. 9 is a cross-sectional view of the wall member, wherein FIG. 9A shows a sectional formation of an engaged concave portion, and FIG. 9B shows a sectional formation of a stepped portion;

FIG. 10 is a perspective view of a lock member viewed from the external side thereof;

FIG. 11 is a perspective view of the lock member viewed from the internal side thereof;

FIG. 12 is a cross-sectional perspective view mainly introducing the condition of the shredder cut at the center thereof in a lateral direction, wherein FIG. 12A shows the condition that the objects relatively thick is introduced into the input port, and FIG. 12B shows the condition that the lock member is released;

FIG. 13 is a cross-sectional perspective view of the line A-A of FIG. 2, wherein FIG. 13A shows an initial state, FIG. 13B shows the condition that the objects relatively thick is introduced into the input port, and FIG. 13C shows the condition that the wall member is largely departed from the initial condition by releasing the lock member;

FIG. 14 shows the input port structure that the objects relatively thick is introduced into the input port so as to apply some pressure against a pressure member, wherein FIG. 14A shows the shredder cut at the center thereof in a lateral direction, and FIG. 14B shows the nearby portion of FIG. 14A;

FIG. 15 shows the input port structure that the disallowed objects such as fingers are introduced into the input port so as to apply large pressure against the pressure member, wherein FIG. 15A shows the shredder cut at the center thereof in a lateral direction, and FIG. 15B shows the nearby portion of FIG. 15A;

FIG. 16 shows the input port structure that the lock member is released, wherein FIG. 16A shows the shredder cut at the center thereof in a lateral direction when releasing a lock, and FIG. 16B shows the shredder cut approximately at the center thereof in condition that the wall member is largely departed from the shredder body; and

FIGS. 17A and 17B both show another embodiments of the wall member and the lock member according to the present invention.

### DETAILED DESCRIPTION OF THE PREFERRED EMBODIMENTS

Preferred embodiments of the present invention will be described with reference to the accompanying drawings. The embodiments of the present invention will not be limited to the ones hereinafter described, but as long as the problems based on the present invention can be solved, any other embodiments are applicable.

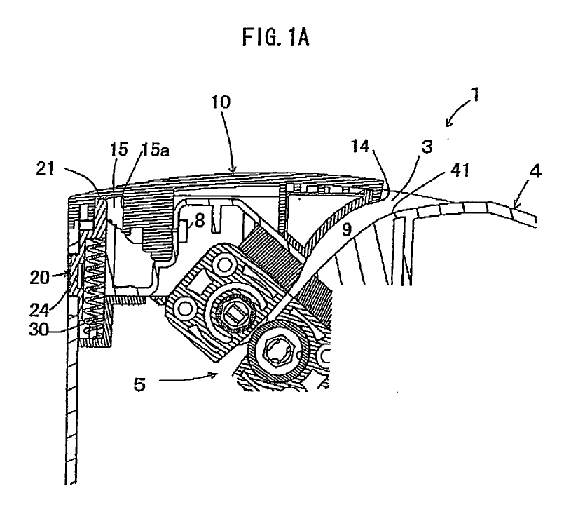

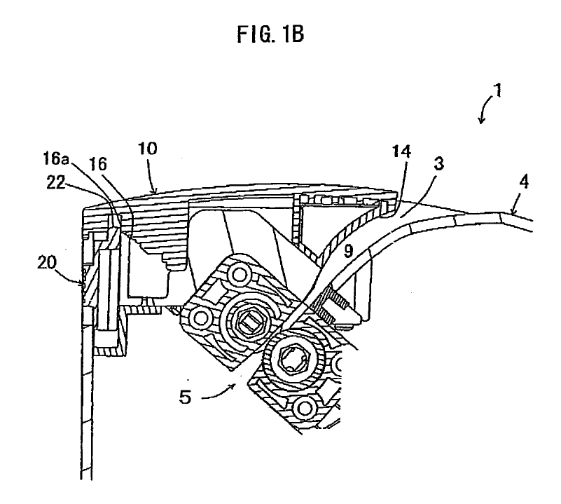

FIG. 1 shows a cross-sectional view according to the present invention, which indicates input port structure 1 of a shredder. This input port structure 1 is applicable to an input port 3 of a shredder 2 of FIG. 2. FIG. 2 shows the shredder 2 cut at the center thereof in a lateral direction. FIG. 1A is a cross-sectional view mainly introducing the portion of the input port 3 of FIG. 2 while FIG. 1B is a cross-sectional view mainly introducing the shredder 2 of the line A-A of FIG. 2. To begin with, the shredder 2, to which the input port structure 1 according to the present invention is applied, will be explained.

This shredder 2 shreds sheet-like materials such as paper or compact discs. The objects introduced from the input port 3 are shredded with a shredded portion 5 provided within a housing and discharged into a waste holding box 6 placed underneath the shredded portion 5.

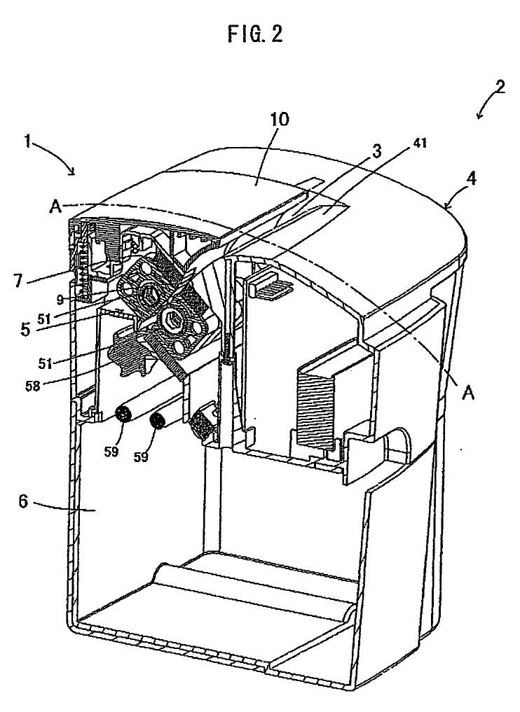

The housing of the shredder 2 is composed of a housing body 4 and a wall member 10. The shredder 2 is fabricated such that the objects are introduced into a space (that is, input port 3) formed between an introduction surface 41 directing from the front side of the housing body 4 to the interior of the housing and the wall member 10 mounted on the back surface side of the housing body 4. Here, FIG. 3 shows the housing body 4 in condition that the wall member 10 is detached from the shredder 2.

In the interior of the housing, a passage 9 directing from the input port 3 to the shredded portion 5 is formed. Underneath the passage 9, the shredded portion 5 worked for cutting operation is provided by being fixed to a frame 7. The shredded portion 5 includes the first rotary cutter 51 and the second rotary cutter 58; the first rotary cutter 51 cut the objects in a lengthwise direction, and the second rotary cutter 58 cut the objects in a lateral direction.

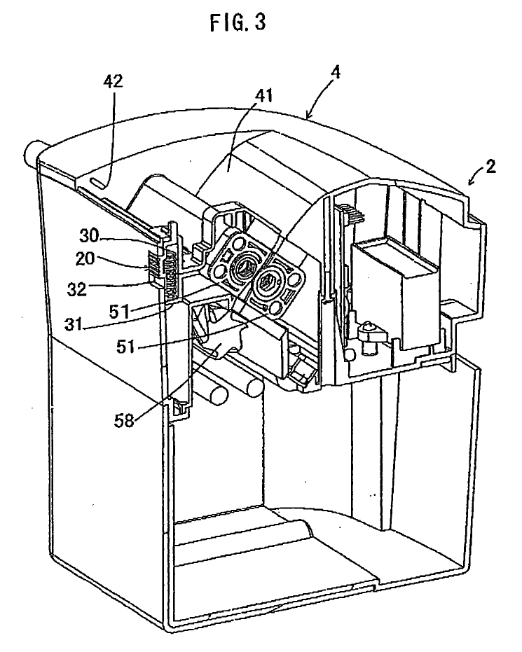

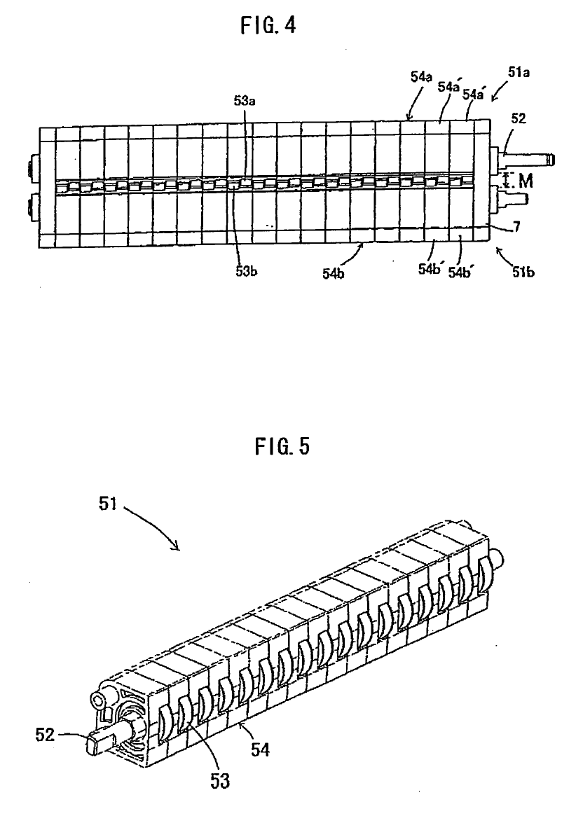

The first rotary cutter 51 sequentially arranged in the passage 9 from the input port 3 contains two sets of rotary cutters 51a and 51b as shown in FIG. 4 in such a manner that the rotary cutters 51a and 51b are faced to each other while housed in rotary cutter cases 54a and 54b. These rotary cutters 51a and 51b are, as shown in FIG. 5, fabricated by arranging a plurality of disk-like circular cutters 53 on a rotary shaft 52 at regular intervals. The circular cutters 53 are arranged on an axis line in parallel.

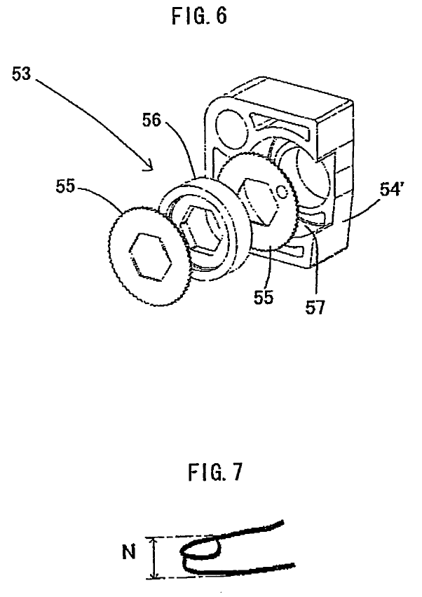

As shown in FIG. 6, the circular cutters 53 of the first rotary cutter 51 are fabricated in such a manner that thin edges 55, 55 having sharp cutting parts therearound are attached to a disc-like spacer 56 on both sides thereof. The circumference portion of each of the thin edges 55, 55 will entangle the objects and cut them in a lengthwise direction. Further, a rotary cutter case 54 is fabricated by arranging a plurality of unit cases 54′ each of which has concavity 57 enable to house one piece of the circular cutter 53. The plurality of unit cases 54′ are also arranged in joint as that each of the concavities 57 is placed in the same direction.

In the above, the concavity 57 of the unit case 54′ is formed as that the circumference portion of the circular cutter 53 is partially exposed out from the unit case 54′. In order to make the circumference portions of circular cutters 53a and 53b exposed brought into contact with each other, a set of the rotary cutters 51a and 51b are collocated. See FIG. 4.

In addition, this unit case 54′ is made of synthetic resin such as ABS resins. because of this, even if the first rotary cutter 51 is in contact with the rotary cutter case 54, the rotary edge will not be damaged. Accordingly, it is possible to fabricate as that there is little space between the circular cutter 53 and the concavity 57. For this reason, even if shredded or cutting waste is attached to the cutting edge of the circular cutter 53 during cutting processes, this waste will be gotten rid of by means of the edge portion of the rotary cutter case 54, contributing to prevention of the waste to be plugged up between the circular cutter 53 and the rotary cutter case 54.

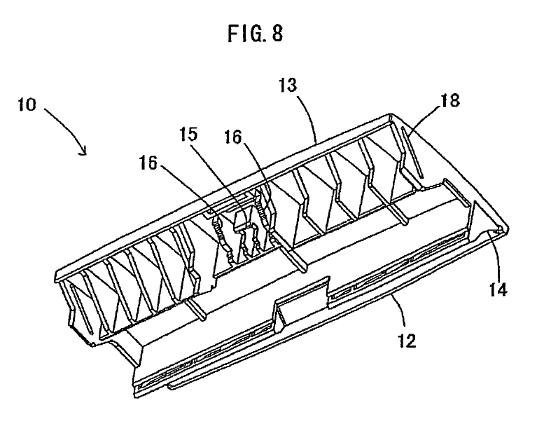

When the first rotary cutter 51 surrounded by the rotary cutter case 54 is arranged in parallel, as detailed in FIG. 4, space M formed between each of the rotary cutter cases 54a and 54b is made to be smaller than the thickness of child fingers by arranging both of the rotary cutters 51a and 51b to be close to each other. Here, as shown in FIG. 7, the thickness of the child fingers is length N. For example, the space M with approximately 2 mm will be a preferable design.

As discussed above, when the rotary cutters 51a and 51b are arranged in parallel, the exposed space in condition that the cutting edges of the circular cutters 53a and 53b are brought into contact with each other is set to be the space M into which the child fingers are not allowed to be entered. With this structure, the fingers of the operators are prohibited to directly touch the first rotary cutter 51.

The second rotary cutter 58 is provided underneath the first rotary cutter 51; the second rotary cutter 58 cuts the objects (having cut in the lengthwise direction with the first rotary cutter 51) in the lateral direction. Beneath the second rotary cutter 58, a guard member 59 is provided so that the operator hands are prohibited from entering into a space portion formed when the waste holding box 6 is drawn out from the housing body 4. This eventually prohibits the operator hands from mistakenly entering into the space where the second rotary cutter 58 is placed. See FIG. 2.

The first rotary cutter 51 and the second rotary cutter 58 are rotated when a sensor (not shown) provided at the introduction surface 41 senses passage of the objects. A drive motor to rotate the first rotary cutter 51 and the second rotary cutter 58 will be workable by turning on a power switch (not shown) provided at the housing body 4.

The interior wall surface of the housing body 4 is provided with a microswitch 8 sensing the displacement of the wall member 10. When the passage 9 is spread by the wall member 10 being displaced, the first rotary cutter 51 and the second rotary cutter 58 will be set to shut down.

Next, the input port structure 1 applied to the shredder 2 will be explained in detail.

In this input port structure 1, the wall member 10 including a wall surface directing to the input port 3 is detachably mounted on the housing body 4 (see FIG. 3) through the lock member 2. That is, on the upper surface of the housing body 4 includes a relatively large opening, and the introduction surface 41 is formed from the front side (in FIG. 2) to the central side thereof. The introduction surface 41 is fabricated with a curved surface smoothly curving directed to the interior of the housing body 4. By placing the introduction surface 41 facing to a passage surface 14 (hereinafter explained in detail) of the wall surface 10, the passage 9 introducing the objects is formed.

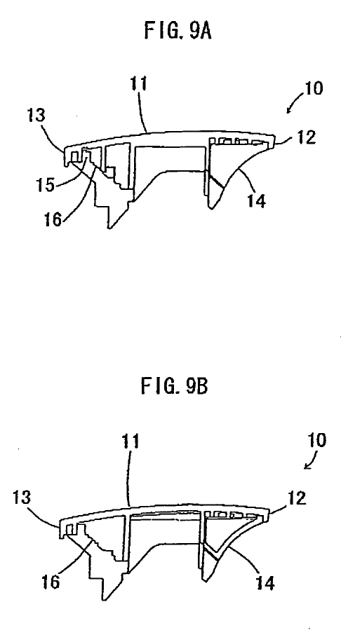

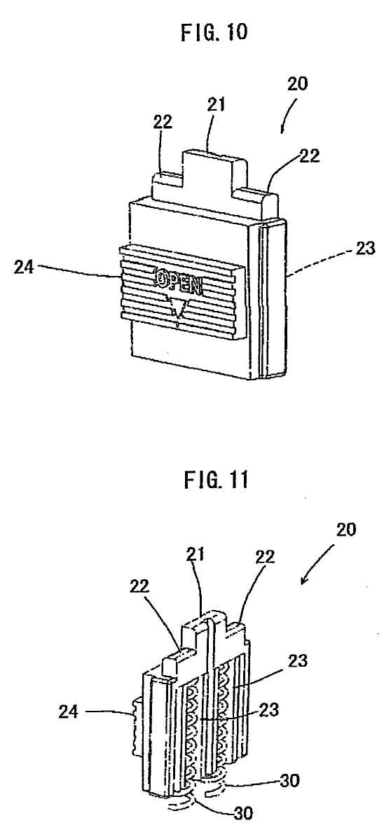

The wall member 10 is mounted in such a manner as to cover the introduction surface 41 of the housing body 4. The structure of the wall member 10 will be explained hereinafter with reference to FIGS. 8 and 9. The wall member 10 forms, when being mounted on the housing body 4, a wall surface directed to the input port 3, on an upper surface portion 11. The rear surface of an input-port side 12 is provided with the passage surface 14. By providing the passage surface 14 in such a manner as to face to the introduction surface 41 of the housing body 4, the passage 9 with a given width is formed, which is correspondent with the curved fabrication of the introduction surface 41.

On the other hand, the reverse side of a back-surface portion 13, on which the wall member 10 is mounted, is provided with an engaged concave portion 15 and a stepped portion 16. That is, on the reverse side of the back-surface portion 13, the engaged concave portion 15 is formed at the center thereof in a lateral direction. See FIG. 9A. On the both sides of the engaged concave portion 15, the stepped portions 16, 16 are formed adjacent thereto. See FIG. 9B. The engaged concave portion 15 fabricated at the center of the housing body 4, as shown in FIG. 1A, houses a convex portion 21 of a lock member 20 (hereinafter explained in detail) so as to maintain the engaged condition made between the wall member 10 and the lock member 20.

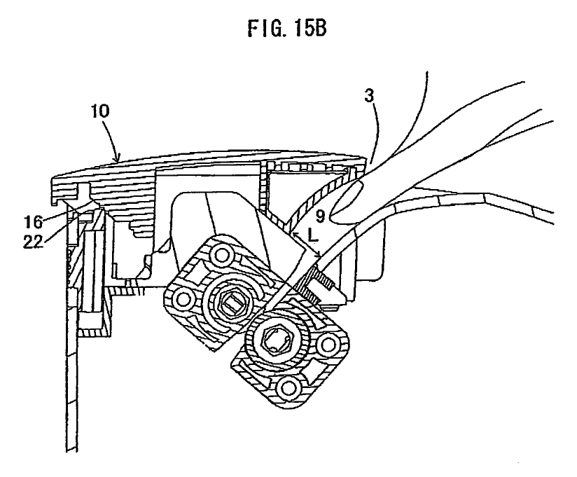

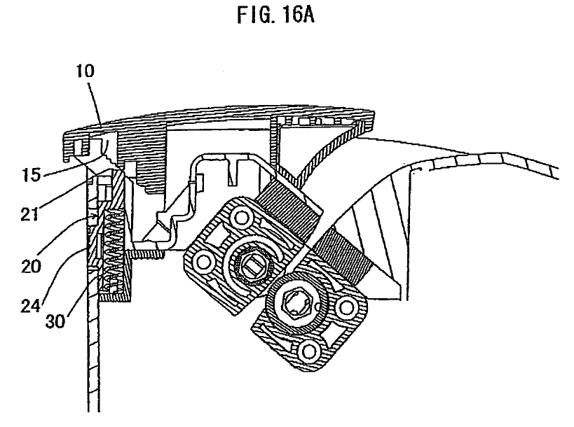

This engaged concave portion 15 retains, even if the wall member 10 is displaced, the size of the inner formation thereof where the convex portion 21 of the lock member 20 is loosely fit. See FIGS. 14A and 15A. In this case, an inner wall 15A of the engaged concave portion 15 is designed to have height as that the convex portion 21 is prohibited from being pulled out by external force in a lateral direction. Accordingly, in case the external force is applied in the direction that the passage 9 is spread (that is, toward the back side of the shredder 2), the wall member 10 is allowed to be displaced within the range that the wall member 10 is not departed in excess from the housing body 4. See FIG. 15A.

A guide groove 18 is formed on the side-wall portion of the wall member 10 so that the wall member 10 can be guided to displace in an upper-side direction. Along the guide groove 18, a projection 42 (see FIG. 3) provided on the inner side wall of the housing body 4 can be slided. The configuration of the engaged concave portion 15 of the wall member 10 is designed in such a manner that when the wall member 10 is departed in the direction to spread the passage 9, a passage width L (see FIG. 15) placed at the terminal of the passage 9 is smaller than the thickness of fingers (for example, approximately 9 mm).

On both sides of the engaged concave portion 15, the stepped portions 16 are each formed. The stepped portion 16 is fabricated in stepped-like formation; each projected height of steps will get sequentially higher from the back-surface portion 13, on which the wall member 10 is mounted, to the input-port side 12. Each step of the stepped portions 16 is designed to have the height (for example, approximately 1 mm) as that by applying external force in the direction to spread the passage 9, each step can be displaced while engaging with an engaged portion 22 (hereinafter explained in detail) of the lock member 20. By providing a curve at the corner of stepped portions 16, the stepped portions 16 can be displaced smoothly on the engaged portion 22.

With the structure described above, in the initial condition that the wall member 10 is mounted on the housing body 4, as shown in FIG. 1B, the engaged portion 22 is engaged with the first-step portion 16a placed on the side on which the wall member 10 is mounted. By displacing the wall member 10 toward the back-surface portion 13, each step of the stepped portions 16 will be engaged with the engaged portion 22. By abutting the convex portion 21 of the lock member 20 to the inner wall 15a of the engaged concave portion 15 of the wall member 10, the displacement amount of the wall member 10 can be restricted.

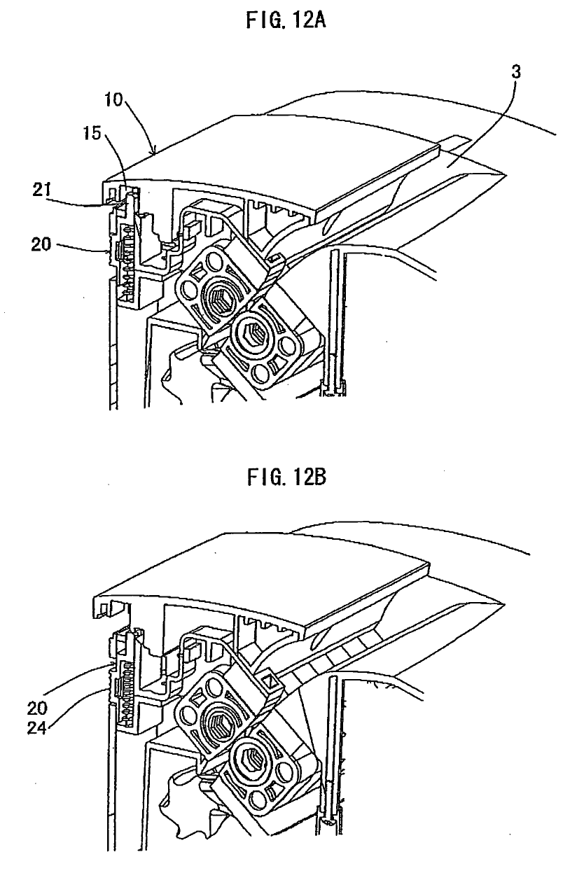

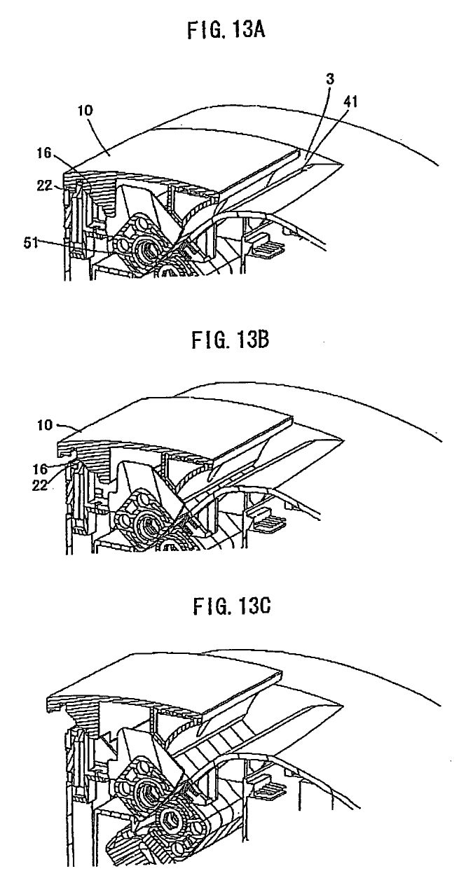

Next, the structure of the lock member 20 will be hereinafter explained. The lock member 20 works as the member to detachably mount the wall member 10 on the housing body 4. The lock member 20 is placed on the upper side of the back surface of the housing body 4. As detailed in FIGS. 10 and 11, the lock member 20 is a plate-like member extended in a lengthwise direction. At the center of the upper-edge portion of the lock member 20, the convex portion 21 is provided projected upward while the engaged portion 22 is each provided on the both sides of the convex portion 21. The convex portion 21 is the member to engage with the engaged concave portion 15 of the wall member 10 while the each of the engaged portions 22 is the member to set on the stepped portion of the wall member 10.

The lock member 20 is provided within the side wall surfaces of the housing body 4 in the condition that the convex portion 21 is placed upward (in FIGS. 10 and 11). By engaging the convex portion 21 with the engaged concave portion 15 of the wall member 10, the wall member 10 is mounted on the housing body 4 so as to form the upper surface of the housing of the shredder. See FIG. 1A. Here, the engaged portions 22 of the lock member 20 is placed at the first-step portion 16a of the stepped portion 16 of the wall member 10. See FIG. 1B.

Underneath the engaged portions 22, spaced portions 23, 23, in which springs 30, 30 (hereinafter explained in detail) are inserted, are provided. On the opposite side relative to the spaced portions 23, 23, an operation portion 24 is formed as that the operation portion 24 works to displace downward the lock member 20 which has been energized upward with the springs 30, 30.

As explained, within the spaced portions 23, 23 of the lock member 20, the springs 30, 30 as an elastic member are placed. Underneath each of the springs 30, 30, as shown in FIG. 3, a fixture 31, which is provided at the back surface of the housing body 4, is fixed to a cylindrical member, whereby the lock member 20 is energized upward.

In the proximity of the fixture 31 of the housing body 4, an opening 32 relatively small is provided, so that the operation portion 24 of the lock member 20 is exposed outside of the housing. In the condition that the operation portion 24 of the lock member 20 is pressed downward, the wall member 10 is lifted up in an upper-side direction so that the convex portion 21 of the lock member 20 is drawn out from the engaged concave portion 15 of the wall member 10. Accordingly, the engaged condition made between the lock member 20 and the wall member 10 will be released.

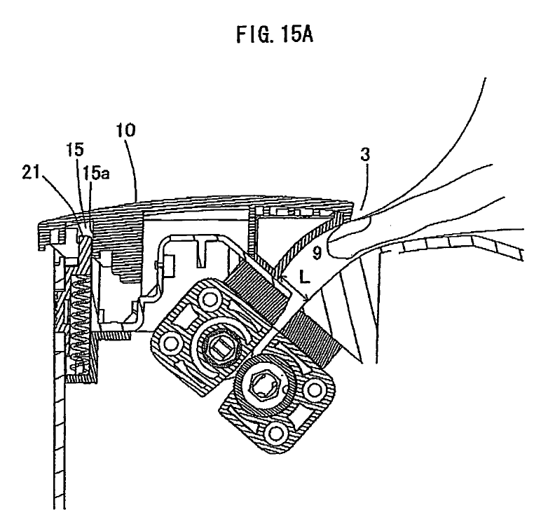

The application of the input port structure 1 based on the above will be explained with reference to FIG. 1 and FIGS. 12 to 16. In order to perform shredded operation, the objects are introduced into the input port 3 in the condition of FIG. 13A. The introduced objects are slided down along the introduction surface 41 and are shredded in a lengthwise direction while being drawn into the first rotary cutter 51 in the housing. The introduced objects are subsequently shredded with the second rotary cutter 58 into a lateral direction to pieces.

Here, in case the large amount of the objects is introduced into the input port 3 of the shredder 2, external force is applied in a horizontal direction relative to the wall member 10. As shown in FIG. 13B, the second and the third steps of the stepped portion 16 of the wall member 10 will be engaged with the engaged portion 22 (see FIG. 14B) so as to slightly spread the passage 9 for the objects. Because of the spread of the passage 9, the operator can concurrently notice that the amount of the objects about to be introduced exceeds a tolerance level. Here, since the passage 9 has been spread, the operator can easily and instantaneously draw out the objects. The engaged condition of the wall member 10 and the lock member 20 of the above situation can be found in FIG. 14A.

If the operator's fingers are introduced into the input port 3 together with the objects 9, large amount of external force is applied against the wall member 10. each step of the stepped portion 16 of the wall member 10 will be displaced while setting on the engaged portion 22 of the lock member 20 (see FIG. 15B) so as to largely spread the passage 9 for the objects.

As discussed above, in case that the fingers are mistakenly introduced into the housing with the objects, especially when the passage 9 becomes a bottlenecked configuration, the fingers are caught in the passage 9 and forced to be drawn further into the interior of the housing. However, the wall member 10 can be displaced so as to spread the passage 9, the operator can instantaneously pull out his fingers from the input port 3.

Here, as shown in FIG. 15A, the engagement between the wall member 10 and the lock member 20 remains so that the displacement region for the wall member 10 is restricted. Accordingly, this can prevent the rapid insertion of the fingers through clearance made by excessive departure of the wall member 10 from the housing body 4. In the present invention, the engaged concave portion 15 of the wall member 10 is designed in such a manner that the maximum width L of the passage 9 when the wall member 10 is displaced is restricted to be smaller than the thickness of the child's fingers. Accordingly, even if excessive external force is applied to the wall member 10, the passage 9 will not be spread to the extent that the fingers are allowed to be inserted to the shredded portion 5. With this structure, even if the fingers are intentionally inserted into the input port 3, the insertion of the fingers is restricted at the end of the passage (that is, the place closest to the shredded portion 5), thereby restricting the fingers to reach to the shredded portion 5.

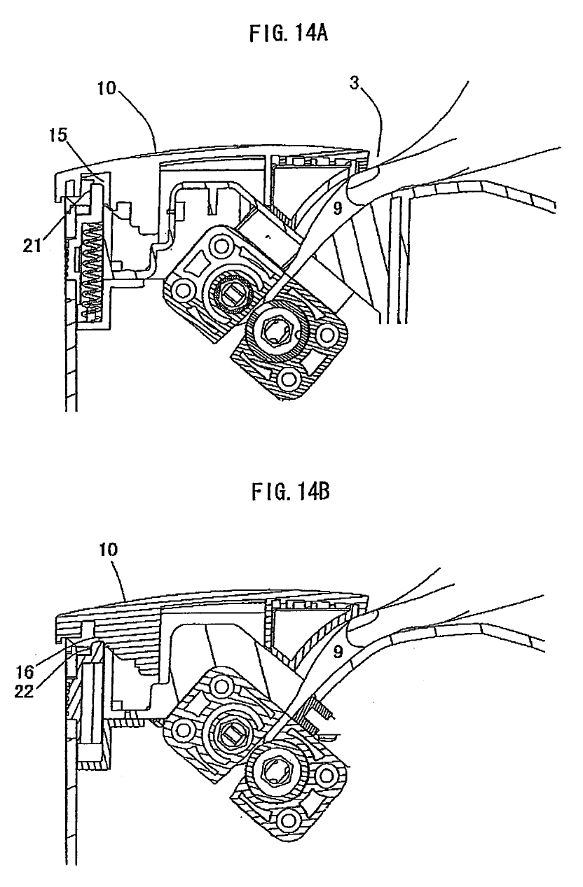

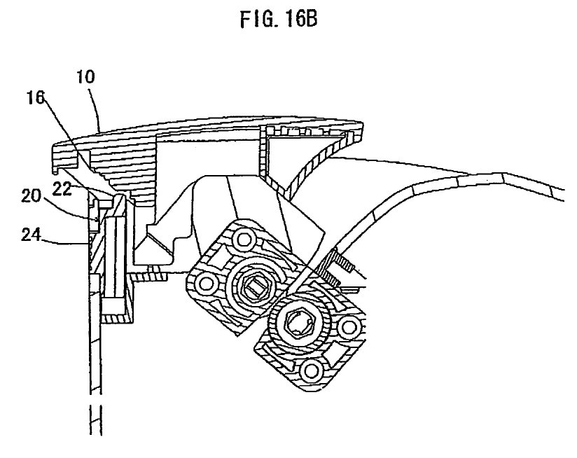

In case that the objects are stuck in the first rotary cutter 51 during the shredded operation, as shown in FIGS. 12B and 16A, the operation portion 24 of the lock member 20 is depressed so as to compress the springs 30, 30. By these processes, the convex portion 21 of the lock member 20 is depressed to the extent that the convex portion 21 is drawn out from the engaged concave portion 15. The wall member 10 is then displaced further in an upper-side direction and stopped at a lock release point as shown in FIG. 16B. Accordingly, the engaged condition made between the wall member 10 and the lock member 20 can be released whereby the objects stuck in the first rotary cutter 51 can be removed by largely departing the wall member 10 relative to the housing body 4.

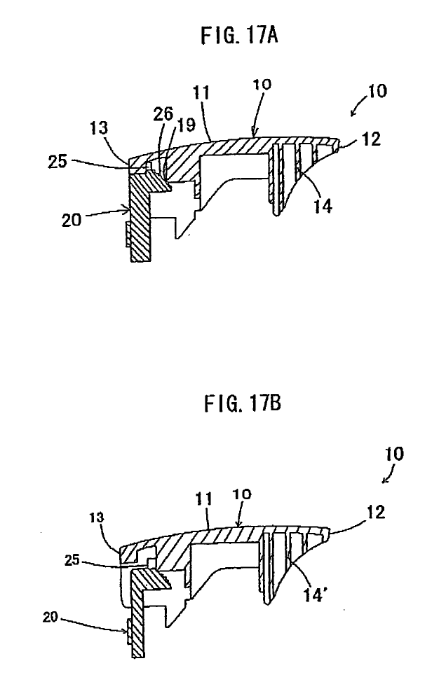

Here, a stepped portion in the present invention may be provided either on the wall member or on the lock member. For example, as shown in FIG. 17, the stepped portion may be provided on the side of the lock member 20. In this case an engaged portion 19 provided on the wall member 10 may be in any kinds of shape as long as each step of the stepped portion 26 can be meshed with the engaged portion 19.

Further, as long as the engagement between the wall member 10 and the lock member 20 remains, it is possible to provide the convex portion 21 on the wall member 10 and the engaged concave portion 15 on the lock member 20. Still further, it is possible to provide the structure that the engaged condition made between the lock member 20 and the wall member 10 can remain by meshing the engaged portion 19 with the final step of the stepped portion 26.

In the present embodiments described above, the convex portion 21 of the lock member 20 is provided on the side wall surface of the hosing body 4 (that is, back surface portion) in the condition that the convex portion 21 is directed upward. The convex portion 21 is then engaged with the engaged concave portion 15 provided on the back surface of the wall member 10. Here, as long as the engagement between the convex portion 21 and the engaged concave portion 15 can remain, it is also possible to provide the structure that the convex portion 21 and the engaged concave portion 15 are engaged in a lateral direction. Or, further complicated structure may be applied in the engagement between the convex portion 21 and the engaged concave portion 15

It is also possible not to provide any lock release means but to provide the structure that the wall member 10 is fixed to the hosing body 4 or the wall member 10 is detachable from the housing body 4.

In addition, it is possible to provide the structure that the input port 3 of the shredder 2 is provided on the side surface of the housing; that is, the side surface of the housing is formed by the wall member 10. Further, depending on the formation or the arrangement of the wall member 10, it is possible that the steps of the stepped portion 26 are arranged in horizontal direction.

Furthermore, it is possible not to provide the passage surface 14 on the back surface of the wall member 10. In this case, as shown in FIG. 17, ribs 14′ may be provided so as to prevent the wall member 10 from being come away from the passage 9. Or, if the passage 9 is structured as that the objects are introduced only on the introduction surface 41, there is no necessity to restrict the upper side of the passage 9.

The present invention can be applied to any types of shredders in households, clerical works or industries.

1. Input port structure of a shredder, the shredder comprising:
an input port;
a wall member including a wall surface directed to the input port; and
a lock member that installs the wall member in a housing body, wherein:
the wall member and the lock member have either a stepped portion with a plurality of steps or an engaged portion being engaged with the steps of the stepped portion; and
by applying given external force to a passage directed to a shredded cutter in a direction to spread the passage relative to the wall member, the steps of the stepped portion engage with the engaged portion while maintaining an engaged condition between the wall member and the lock member.

2. The input port structure of the shredder according to claim 1, wherein:
the stepped portion is provided on the backside of the wall member; and
a convex portion provided on the lock member is housed within a concave portion provided nearby the stepped portion so as to engage the wall member with the lock member.

3. The input port structure of the shredder according to claim 2, wherein;
the stepped level of the stepped portion is made elevated from the side on which the wall member is mounted to the side of the input port; and
in the initial state that the wall member is mounted on a housing body, the engaged portion is engaged with the first-step portion positioned on the side on which the wall member is mounted.

4. The input port structure of the shredder according to claim 2, wherein:
the lock member is provided on the side-wall surface of the housing body in condition that the convex portion is directed upward toward the wall member; and
the convex portion is housed within the concave portion of the wall member so as to apply the wall member as the upper surface of the housing.

5. The input port structure of the shredder according to claim 1, wherein a lock releasing means is provided so as to release the engaged condition applied between the wall member and the lock member.

6. The input port structure of the shredder according to claim 5, wherein:
the lock releasing means intervenes between the housing body and the lock member;
the lock member is made of an elastic member which energizes the lock member in the direction of the wall member; and
an operation portion is provided so as to release the emerging force applied by the elastic member.

7. The input port structure of the shredder according to claim 1, wherein:
an introduction surface for introducing objects to be cut into the shredded cutter is provided on the housing body; and
a passage surface, provided opposite to the introduction surface so as to form a passage with a certain width, is provided on the back surface of the wall member.
